(19) United States
(12) Patent Application Publication
(10) Pub. No.: US 2010/0214609 A1
(43) Pub. Date: Aug. 26, 2010

(54) Process for storing and accessing documents by facsimile

(76) Inventors: Diwakaran Avinash Ratnam, Woodbury, MN (US); Colleen Marie Canning, Woodbury, MN (US)

Correspondence Address: Mark Edward Reeves, 238 Dunbar Way, Mahtomedi, MN, 55115-2814, US

(21) Appl. No.: 12/711,241

(22) Filed: Feb. 23, 2010

Related U.S. Application Data
(60) Provisional application No. 61/154,590, filed on Feb. 23, 2009.

(51) Int. Cl. G06F 15/00

(52) U.S. Cl. 358/1.15

(57) ABSTRACT

A method for storing an image of a paper document with the steps of: relating an indexing image with the document, faxing the document and related indexing image to a fax server and storing the image of the document and information conveyed by the indexing image.

### CROSS REFERENCE TO RELATED APPLICATIONS

This application is based on provisional application Ser. No. 61/154,590, filed on Feb. 23, 2009.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of electronic storage of documents and more specifically to a process for storing an image of a paper document.

Making and keeping the information contained on important paper documents accessible has been a problem for some time. An executor of an estate may have to search extensively for documents such as a will or insurance polices not being sure they even exist. In the case of a fire or flood in a home, important documents may be destroyed.

There are means for storing and retrieving electronic files over the internet. These online storage systems require the use of a computer to create and store the files. To store a copy of a paper document online requires either a scanner or a camera to capture the image, store it locally, assign it a file name, and upload the file over the internet to a server for storage. This is beyond the capability of many people who are not experienced computer users or don't have access to the required equipment.

### BRIEF SUMMARY OF THE INVENTION

An object of some of the embodiments of the invention is to provide a way of storing documents in electronic format by using a fax machine without requiring the use of a computer.

Another object of some embodiments of the invention is to provide a way for people to access the information on paper documents without having the physical possession of the documents.

Another object of some embodiments of the invention is to provide a way to help people select documents which contain important information that should be accessible regardless of the location or condition of the original documents.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a method for storing an image of a paper document comprising the steps of: relating an indexing image with the document; faxing the document and related indexing image to a fax server; and storing the document image and information conveyed by the indexing image.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1—A schematic block diagram of components present in some embodiments

FIG. 2—Examples of indexing images

FIG. 3—An illustration of a user interface for printing indexing images on a cover page

FIG. 4—Relating indexing images with documents

FIG. 5—Documents with related indexing images combined to be faxed together

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

### Definitions:

Document is any sheet of paper or plastic with written or printed information. This also includes items which can be scanned such as photographs, credit cards, ID tags, books, etc.

Document image is the electronic data file stored as a result of the faxing the physical document to the fax server.

Faxing is the process of transmitting an electronic image or facsimile of a physical document to a fax machine or a fax server. This would include the creating and transmitting a document image to a fax server as well as the sending of a stored document image to a receiving fax machine. It is not specific to any one of the standards that define the details of how a fax is transmitted from one machine to another.

Fax machine is a device capable of receiving and printing a faxed document image and is capable of scanning a document and transmitting a document image to another fax machine or a fax server. It may be a machine dedicated to sending and receiving faxed document images or may be part of a multi-purpose copier or printer.

### Structure

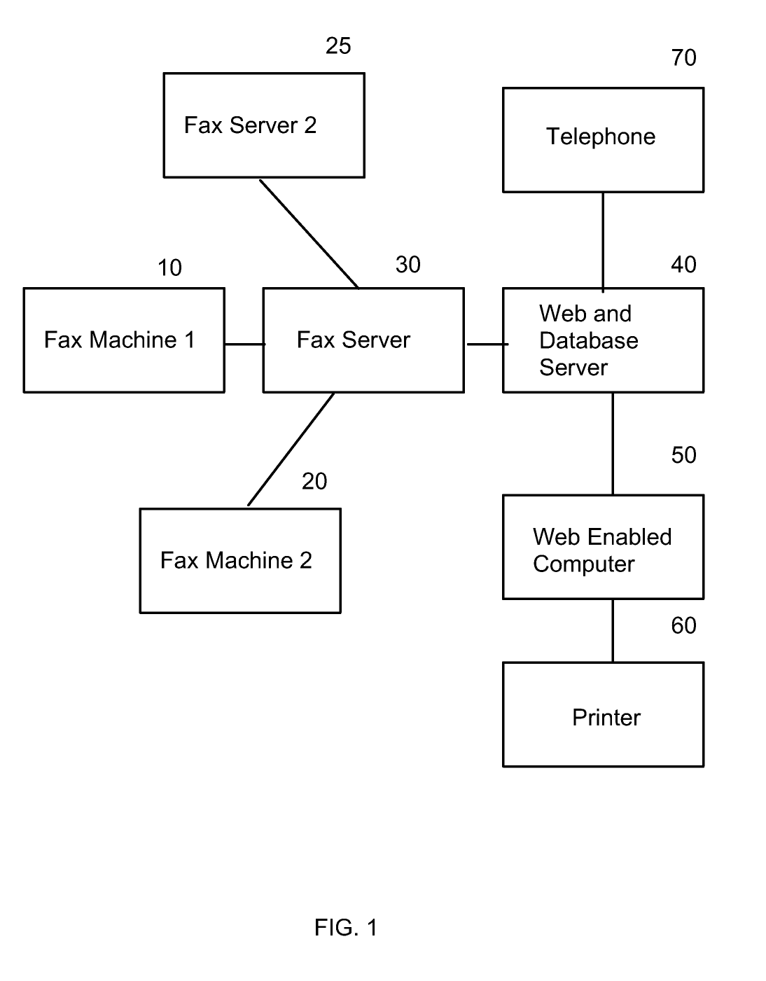

The structure for some of the embodiments is shown in FIG. 1. Fax machine 1 (10) is connected to the fax server (30) by a means of communication. Typical means include the telephone system (typically Public Switched Telephone Network (PSTN) or Voice Over IP (VOIP)) and the internet (Fax Over IP). However, other means may develop without departing from scope of this disclosure. The fax server (30) is the hardware and software that communicates with the fax machines 1 and 2 (10) and (20), receives incoming faxes, sends outgoing faxes, stores incoming faxed document images, processes and stores or sends to the database server (40) additional information contained in the fax header and within portions of the faxed document images. Several types of fax devices may be used. Examples of fax devices include (but are not limited to) fax cards (such as the Brooktrout TR114 DID card), active ISDN fax cards (such as the AVM 81 ISDN fax card), fax modems class 1 or class 2 or class 2.0. An example of fax server software is GFI FAXmaker by GFI Software. As well known in the industry, the components of the fax server may reside in one location or several. The fax device(s) need not be collocated with the data storage device(s).

The fax server (30) is connected over a network to a web and database server (40). The web and database server hosts the software for the user to selectively access the stored document images. Examples of software that may be utilized on the web and database server is Microsoft Server and HTML programming language. The web and database server (40) may send confirming emails or other electronic messages such as text messages or Short Message Service (SMS) notifications to the user to confirm receipt of images and other information such as time and number of pages.

In some embodiments, an internet capable device such as a computer or smart phone (50) connects to the web and database server (40) over the internet using the appropriate protocols. The internet capable device (50) is optionally connected to a printer (60) directly or over a network.

In some embodiments, a telephone (70) connects to the web and database server by telephone lines (either PSTN or VOIP). The telephone (70) may be either a “land line” or a mobile phone.

### Relating an Indexing Image to a Document

When storing a document whether in a physical, paper form or in an electronic format, it is often desirable to include some information to make retrieving the document easier. In some embodiments, information about the document being faxed for storage is conveyed by use of an indexing image. For this application, indexing image is a machine readable image that when identified by the fax server, allows the fax server to associate information with the document image. Some examples of the information that may be associated include (but are not limited to), the owner of the document image and a category of the subject matter contained in the document image.

In this application, the term owner is defined to mean person or persons with authority to access the document image. The owner of the document image may or may not be the owner of the physical document.

Some examples of the subject matter categories include (but are not limited to), Emergency Documents, Travel, Health Records, Insurance Documents, Financial, Legal, Investments, Certificates, Licenses/Registration/Titles, Wills, and Other Important Documents. In addition, there may be a miscellaneous category for documents not fitting any category. This miscellaneous category may also be for document images where no category is indicated. In some embodiments, additional, unlabeled categories may be available for or created by the user allowing them to store document images of a category not predefined.

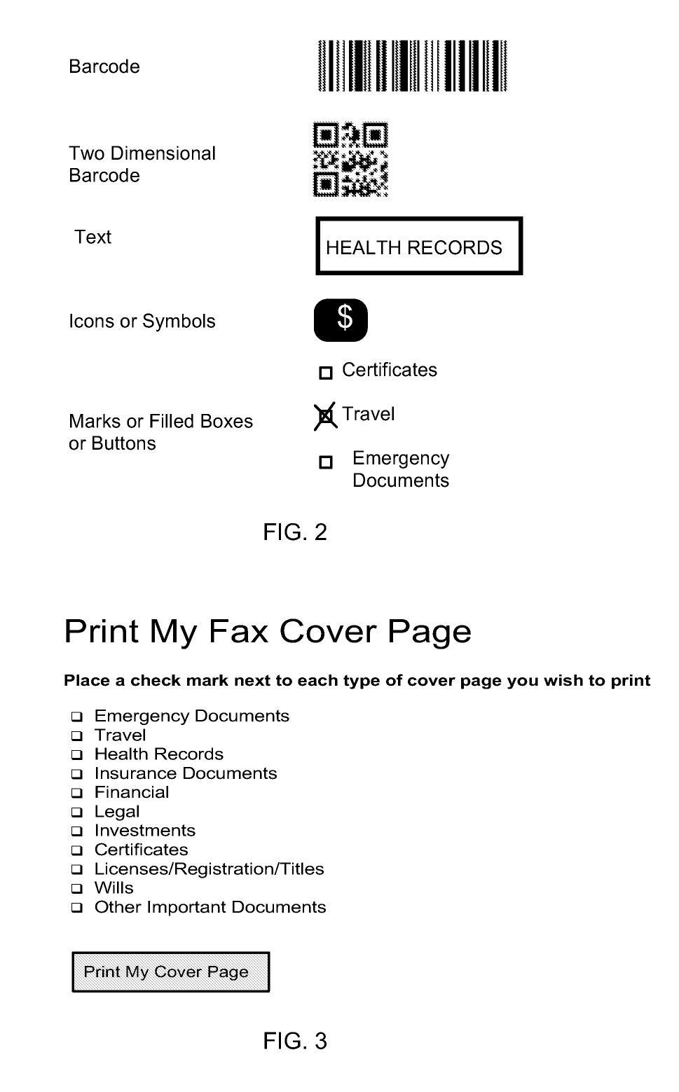

Some examples of indexing images, some of which are shown on FIG. 2, include (but are not limited to), standard barcodes, two dimensional barcodes, icons, numbers, letters, symbols, and other graphical images. In some embodiments, the indexing image may also be a mark placed in a specific location on a page. In some embodiments, the indexing image may also be a mark or filled in box or circle on a form.

In some embodiments, the indexing images are printed by the user off the internet or from a file or program on a local or networked computer or server. An example user interface for a web application or a locally executed program is shown in FIG. 3. In some embodiments, the indexing images are preprinted as cover sheets, trailing sheets, or on adhesive backed labels and sent or delivered to the user.

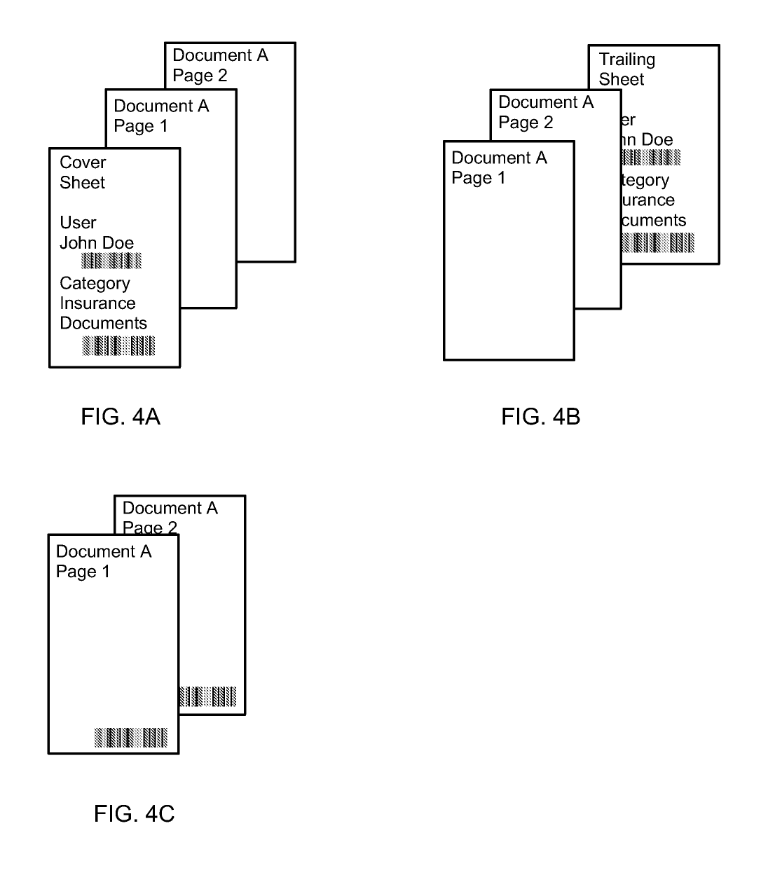

The user may select one or more indexing images and relate them to the document to be faxed to the fax server. The term relate in this application means to place the index image in such a way that the fax server may identify the indexing image and store the information conveyed by the indexing image with the document image to which the indexing image information is associated. In some embodiments, this may be done by placing a sheet with the appropriate indexing image or images printed on it ahead of the document when it is faxed as shown in FIG. 4A. In some embodiments, this may be done by placing a sheet with the indexing image printed on it behind the document when it is faxed as shown in FIG. 4B. In some embodiments the indexing image may be placed on the physical document using a sticker with the indexing image printed on it or by printing the indexing image directly on the document as shown in FIG. 4C.

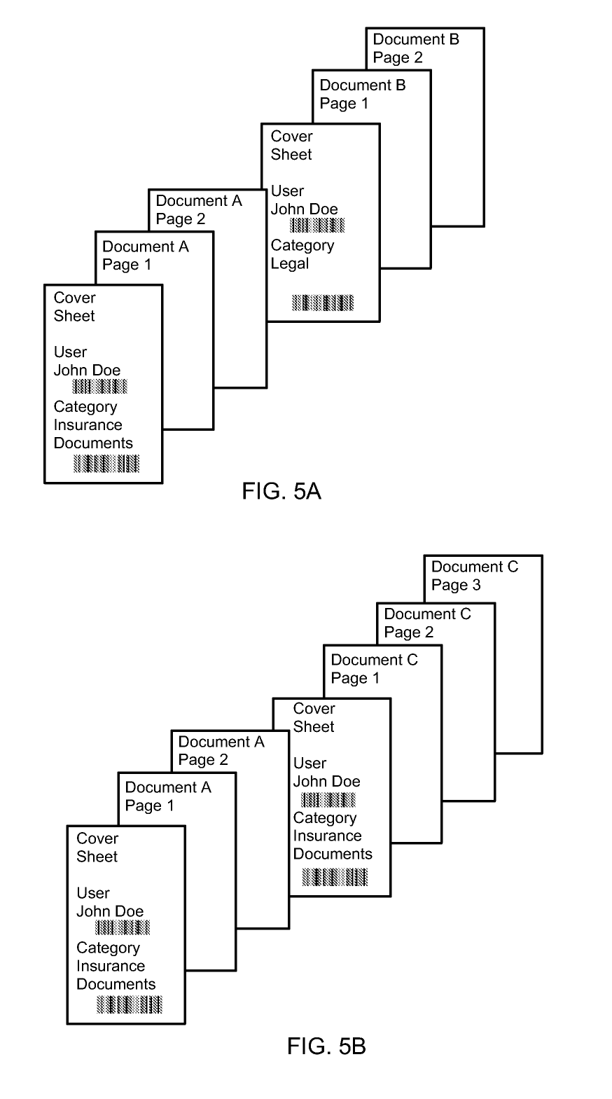

In some embodiments, documents to be saved to different categories may be sent to the fax server in one batch by separating the documents by cover sheets or trailing sheets specifying the category for each set of document pages as shown in FIG. 5A. In some embodiments, documents of the same category may be separated by identical cover or trailing sheets as shown in FIG. 5B. This may be advantageous in embodiments where the first document page of each new category in a single fax may be selected for display or for a thumbnail to be sent to a fax machine for a user to select which full sized images should be sent to the fax machine.

In some embodiments, each user is assigned a unique fax phone number. Index images are not required to convey the ownership information, but may be used to specify the category into which the document image should be placed.

### Faxing and Storing the Indexing Image and Related Document Images

When the indexing image and related document image or images are received by the fax server, the fax server will decode the information conveyed by the indexing image. In some embodiments, software for decoding barcodes in fax transmissions is used. In some embodiments, optical character recognition software is used. In some embodiments, software, for identifying icons, symbols, or graphical images, or the location of marks is used.

The indexing image information and document image are saved in a manner that keeps the relationship between them. Several methods exist for this including (but not limited to) saving the information in a database with links to the document image; and saving the document image in directory tree where the names of the directory and sub-directories contain the indexing image information.

In some embodiments, additional information is saved and associated with the document image. Such additional information may include (but is not limited to) time and date of transmission, fax machine identification, fax machine phone number, and other data contained in the fax header.

In some embodiments, the fax server, FIG. 1 (30) sends a fax back to the sending fax machine (10) with information regarding the fax received. Examples of information which may be faxed back include (but is not limited to) number of pages received, number of pages for each category, time and date, and a thumbnail image of each page received or the first page received of each category. In some embodiments, it is possible to indicate whether or not to send information back to the sending fax machine by using an indexing image such as a mark on a form. In some embodiments, an email is sent from the web and database server (40) to the user email account with information regarding the fax received. In some embodiments this option may be selected as part of a user profile established through the website for the storage service provider. In some embodiments, the email option may be indicated on the cover sheet by using and indexing image such as a mark on a form.

In some embodiments, the document image is encrypted. In some embodiments, the encrypted document image is only decrypted when accessed by the owner or other authorized person. In some embodiments, the document images are not converted to searchable files via optical character recognition software.

### Retrieving the Document Image

Various means may be utilized to access the saved document images. Some embodiments utilize one or more fax machines. Some embodiments utilize a telephone and one or more fax machines. Some embodiments utilize only the internet, accessed through an internet capable device (50) such as a computer or smart phone. Some embodiments utilize the internet, accessed through an internet capable device (50) such as a computer or smart phone, and a printer.

In embodiments where the document image or images are sent to a fax machine, that receiving device may be a stand alone fax machine (20) or it may be a second fax server (25) which will receive the fax and store it or send it to the recipient by means such as email or a printed document.

Some embodiments have an option of using a telephone to request document images be sent to a specified receiving fax machine (10), (20), or (25). This telephone may connect to the web and database server (40) by either a land line (over PSTN or VOIP systems) or by using a mobile phone system. The user would call a phone number and enter data such as (but not limited to) phone number of fax to which the document images should be sent, account or id number, and personal identification number or password number. Entering of such information may be by key pad, voice, or a combination thereof. In some embodiments, it is possible to specify one or more categories to be faxed. In some embodiments, all stored document images are faxed to the specified fax machine.

Some embodiments have an option to send a fax to the fax server (30) requesting document images to be sent to a fax machine (10), (20), or (25). The document which is faxed to the fax server utilizes indexing images to make the request. The requesting document may be printed off the internet, printed from file or program residing on a local computer or network. In some embodiments, a preprinted requesting document may be supplied to the user by the storage service. The indexing images on the requesting document convey the information about which documents, document categories, or if all documents should be sent either to the requesting fax machine or a different fax machine. In some embodiments, the document images must be faxed back to the requesting fax machine.

In some embodiments, the fax server may be requested by fax to send a fax with thumbnail images of one or more or all of the stored document images. In some embodiments the thumbnail images are of every page or every page in a specified category. In some embodiments, thumbnails of only the first pages which follow a cover sheet (or the first pages of a category where the index image is printed on a trailing sheet or the first page after a change in category indicated on labels attached to each document page) are printed. The user then may indicate which document pages should be faxed to the receiving fax machine by means such as making a mark on the thumbnail page and faxing the sheet back to the fax server. The fax server will read the indicating marks or images and fax the indicated documents to the specified fax machine.

In some embodiments, a document sent to a receiving fax machine with thumbnail images of documents which may be selected for faxing to a fax machine may include a reference number associated with each thumbnail image or groups of thumbnail images. The user may the use a phone in system similar to the embodiments described above and enter a reference number to request specific document images.

In some embodiments, the user may request by phone that a fax with thumbnails of all the document pages, all the document pages in a specified category, or thumbnails of the first document page of each category from each fax be sent to a fax machine. The user may then review the thumbnails and indicate which documents to send by placing identifying marks on the faxed sheet of thumbnails and faxing the sheet back to the fax server for the fax server to fax the indicated document images to the specified fax machine. In some embodiments, the faxed sheet of thumbnails include reference numbers associated with each thumbnail or group of thumbnails which may be entered by phone to request a full sized copy of the document be sent to a fax machine.

Some embodiments have an option to access the document images over the internet. The user logs on to the fax server or database and is able to view the images on the computer screen or smart phone. The documents may be printed, faxed to a fax machine or server, downloaded to a location specified by the user, sent by email, or deleted from the fax server. In some embodiments, the document images displayed, printed, downloaded, or emailed are PDF files.

In some embodiments, the user may move the document images from one category to another. In some embodiments, the user may specify a document image should appear in more than one category.

In some embodiments, the user must use pre-defined categories. In some embodiments the user may rename one or more or all of the categories. In some embodiments, the user may create one or more additional categories.

In some embodiments, the owner of the document images may grant access to one or more of the document images to one or more individuals. In some embodiments this is done by specifying the email address or user name or other identifier of the user to be granted access and the categories to which access is granted. In some embodiments, the user is sent an email notifying them they have been granted access to one or more of the categories by the owner. In some embodiments access to individual document images may be specified.

In some embodiments, a user may be granted access to one or more document images by more than one owner. In some embodiments where access is granted to the user based on a user specific identifier such as (but not limited to) user name or email address, the user may access all document images the user is authorized to access without having to logout and log back in to different accounts. In such embodiments, the accessible document images may be sorted by properties such as (but not limited to) user, category, and date and time received by the fax server.

In some embodiments, a log is kept detailing activities every time a document is accessed. The details recorded may include (but are not limited to) who did the accessing (based on some identifier such as username, password, or IP address); when the file was accessed; what was done such as (but not limited to) download, email, fax, delete, etc.; and the recipient of a document image if it was downloaded, faxed, emailed, or printed. Document logs for one or more document images may be viewed, downloaded, printed, faxed, or emailed as a group organized by folder or owner.

### Assisting the User in Selecting and Organizing Document to be Stored

In some embodiments, it is desirable to assist document owners and users in selecting documents to be faxed for storage on the fax server. In some embodiments, lists of relevant documents for given situations or for a given category are made available to the document owner or user. For example, a list for someone who is designated to be an executor of an estate, important documents to make available may include the person's will, life insurance policies, funeral plans, and people to contact such as relatives, lawyer, insurance agent, etc. A list for a traveler going abroad may include their passport, itinerary, credit card numbers, U.S. embassy contact information, etc.

In some embodiments, a kit is provided to new users of this service. Contents of the kit may include (but is not limited to) cover sheets with the indexing image appropriate for each category, information on how to sign up for the service, information on costs for using the services, and a DVD with instructions on how to choose documents for storage, send them to the fax server, and access the stored document images.

In some embodiments, the kit is customized for a target audience. In addition to the information on how to use the service and copies of the indexing images, this customized kit may include general information on the subject of the kit, information on choosing relevant documents, a notebook to keep the original documents, copies of the original documents, or the location of the original documents. In some embodiments, this kit is supplied to the user by someone in a business related to the subject matter of the kit. In some embodiments, the kit is designed to indicate it is part of a service provided by the business developing the customized kit. In some embodiments, the kit developer and the provider of the storage service share revenue from fees for storing the document images.

In some embodiments, third parties with expertise in a specific area may develop lists of documents and information relevant to those documents. In some embodiments, this information is posted on the website of the storage service. In some embodiments the availability of such information is advertised on the storage service website with links to the information located elsewhere.

In some embodiments, the users of the storage service may interact with the third parties. This interaction may take several forms such as (but not limited to) subscribing to newsletters or blogs and following the third party on networking sites such as Facebook or Twitter.

In some embodiments, the user personalizes the information received by indicating information relevant to their situation. The third party may then customize the lists of documents or information. For example, someone who is designated to be an executor of an estate may interact with a third party to prepare for that task before it happens. Relevant information would focus on gathering documents such as the will, insurance policies, funeral instructions, contacts such as relatives, insurance agents, and lawyers, etc. When the time comes to serve as the executor, the information would change to collecting documents that relate to settling the estate such as a death certificate, property appraisals, distribution of property, etc.

In some embodiments, as the importance of documents changes due to changes in laws or due to the passing of time, a third party may communicate with the user regarding the need to update, add, or delete documents. In some situations, the third party may be granted access to certain stored document images to review the content of the documents and recommend any needed actions. Example of situations where this may occur include (but are not limited to) an attorney involved in settling an estate, or assisting in adoption proceedings; an accountant preparing a tax return; or a mediation service dealing with documentation between estranged or hostile parties. While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A method for storing an image of a paper document comprising the steps of:
Associating an indexing image with the document
Faxing the document and associated indexing image to a fax server
Storing the document image and information conveyed by the indexing image.

2. The method in claim 1 further comprising the step of retrieving a copy of the stored document image.

3. A document storage system comprising:
A fax server,
One or more fax machines connected to the fax server so as to be able to send and receive faxed documents from the fax server,
One or more indexing images related to a document faxed for storage,
A web and database server connected to the fax server by a network, and
Software to read the indexing images and store on one or both the fax server and the web and database server the document image and information associated with the document image.

4. The document storage system of claim 3, further including:
A telephone connected to the web and database server, and
Software to receive information input from the telephone, verify the information and to direct the fax server which document images to fax and the fax number of the receiving fax machine.

5. A method of assisting one or more people in selecting and accessably storing documents comprising:
Providing information relevant to the document needs of the people,
Providing means of organizing important documents,
Providing reprinted sheets with the appropriate indexing images, and
Providing information on how to store and retrieve document images by using a fax machine.
